(19) United States
(12) Patent Application Publication
(10) Pub. No.: US 2013/0246960 A1
(43) Pub. Date: Sep. 19, 2013

(54) Communication System for Emergency Response Teams

(71) Applicant: Eric Saylors, El Verano, CA (US)

(72) Inventor: Eric Saylors, El Verano, CA (US)

(73) Assignee: Mobius Exchange, Inc., Bend, OR (US)

(21) Appl. No.: 13/796,075

(22) Filed: Mar. 12, 2013

Related U.S. Application Data
(60) Provisional application No. 61/611,970, filed on Mar. 16, 2012.

(51) Int. Cl. G06F 19/00

(52) U.S. Cl. CPC G06F 19/3406
USPC 715/771

(57) ABSTRACT

A communication system for emergency first responders provides a unique software application (“app”) used on a handheld tablet (for example, an iPad®) and web-based platform to aid with dispatch, communications, scene management, documentation, records, and billing of 9-1-1 emergency medical calls. A “thin” web-based client is viewable through the Internet, including wirelessly from within emergency vehicles, and communicates with a main system that is designed around a core-layered architecture with at least one system database and a web-based interface. The system facilitates report entry and delivery to hospitals and end-user administration, including the ability to create new fields for the e-PCR, notifications about relevant data conditions, continuous reporting capabilities, and en route updates.

### CROSS-REFERENCE TO RELATED APPLICATIONS

This application claims the benefit of the filing date of U.S. provisional patent application No. 61/611,970 filed Mar. 16, 2012.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

For many years, ambulance paramedics have had a significant problem with the documentation of an emergency incident. The Patient Care Report, or PCR, has traditionally been a pre-formatted form the paramedic fills out on a clipboard or on a desk at the hospital after delivering the patient to the ER. Vital information from the medic gives the ER doctor a clear picture of the situation. A completed PCR plays an integral part in the patient's care.

Using a clipboard is slow and awkward and is often a hindrance during the chaos of an emergency scene. Handling a heavy patient, with tubes, wires, monitors, blood, vomitus, trip hazards, and every other imaginable obstacle that is encountered in the dark and fog of an emergency scene is not conducive to clipboard use.

In the past, to aid with their recall, most paramedics have pre-applied masking tape to their uniforms (“turnouts”). On this tape, the medics write notes about the patient and the emergency call, and later, after the call is finished, they complete the PCR based on these notes and their recall.

The net result is that critical documentation is incomplete, insurance carriers cannot be billed correctly or fully; and insurance payments to fire departments, EMS agencies and ambulance companies are deficient. Further, patient care suffers, providers of ambulance services become vulnerable to lawsuits, and fire and EMS Departments are faced with a labor intense system and high clerical costs stemming from gathering and collecting PCRs, faxing, and storage of documents.

The use of laptop computers in the field with a software template specifically designed for an individual agency was introduced about 10 years ago. This laptop template has met with very little success in the field because of several factors.

First, “Toughbook®” type laptops cost approximately $5,000 each. Second, laptops are difficult to maintain when subjected to an emergency environment. Further, extreme conditions make warranties cost prohibitive or unavailable. Keyboards and USB ports are subject to contamination from blood and other fluids. Finally, the laptop is cumbersome and awkward to use in an emergency scene. Because of the above, fire department and EMS administrations have directed paramedics to leave the laptops inside the ambulance.

Even with the laptop method, the completed PCR must then be printed and faxed to a billing company for insurance processing and payment. For a long time, paper PCRs with carbon copies have been used to share this information between ambulance crews and emergency room staff. When data is on paper, it is not in a form that lends itself to easy or quick summary or analysis, because, for one reason, doing so would require vast amounts of data entry. When data is on paper, it is therefore impossible to get instant results to research questions, and protocol violations are difficult to detect and handle. With slow paper processes that need to be reconciled with other information systems, such as dispatch information, GPS information, and fleet maintenance information, opportunities for research on clinical data from ambulance trips remain untapped. For this reason, many organizations spend a tremendous amount of effort, time, and money on entering paper-based data into electronic databases.

2. Description of Related Art Including Information Disclosed Under 37 CFR 1.97 and 1.98

Currently, there are some systems for managing medical data that employ Palm Pilot and/or other PDA operating systems for data collection, including Pocket PC and Windows CE®. Many of these applications have been custom built by individual organizations. A problem with this approach is that Palm Pilot-style applications, Windows CE® applications, and pocket applications cannot be synchronized with the parent computer-aided dispatch database without taking them back to the location of the parent database for synchronization.

Another existing option is a client/server patient data collection system. Examples of commercial client/server systems with so-called “thick” clients are those from Firehouse, PhisioMedusa, BioKey, and Zoll. Some systems have also been custom built—for example, the State of Delaware has developed a client/server-based system in which the client is installed in PCs throughout the state and then each client individually communicates back to the main state server. All of these applications require some type of client/server synchronization function. Further, installation and maintenance of the full computer needed to run the client for each individual ambulance crew would require a great deal of labor and money, and the systems do not necessarily integrate with other software already being used, such as existing installed computer-aided dispatch and/or billing software.

Clearly, an electronic patient-data collection mechanism is needed, one that easily and instantly integrates with the computer-assisted dispatch. However, it can be extremely expensive, as well as time-consuming from a labor standpoint, to purchase hardware and to have someone administer the hardware and make sure that the machines are accurate and synchronized.

### BRIEF SUMMARY OF THE INVENTION

The unique system described herein is an integrated web-based software and electronic touch-screen tablet system for tracking and managing patient care reports associated with emergency medical transport trips. In one aspect, a “thin” web-based client is viewable through the Internet, including wirelessly from within emergency vehicles, and communicates with a main system that is designed around a core-layered architecture. The system supports all of the activities associated with the process flow of patient care report form entry, delivery, and retention. Particular benefits include facilitation of end-user administration, provision of notifications about relevant conditions, continuous reporting capabilities, and en route updates. In one aspect, the system provides prefilled web forms, changeable data entry, automatic information sharing, quality assurance and conditions notifications, summary data, and data analysis. In another aspect, a tablet device is provided with software that renders screen displays of actual gauges and dials simulating actual equipment though which data may be entered by touching appropriate alphanumeric values. In yet another aspect, the system provides functions for creating, editing, deleting, and managing reports generated from the patient care report record database. The system provides a mechanism to specify and generate notifications based on various system events and further provides a mechanism through which patient care report records can be locked from further changes to preserve accuracy.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a block schematic diagram of a system for managing medical data for EMS patients.

FIG. 2 is a screen rendering on an electronic tablet of a login page.

FIG. 3 is a screen rendering on an electronic tablet of a unit and crew page.

FIG. 4 is a screen rendering on an electronic tablet of a unit's pop-up menu on a unit and crew page.

FIG. 5 is a screen rendering on an electronic tablet of a date and time entry pop-up window on a unit and crew page.

FIG. 6 is a screen rendering on an electronic tablet of a unit and crew page.

FIG. 7 is a screen rendering on an electronic tablet of an incidents page.

FIG. 8 is a screen rendering on an electronic tablet of active incidents on an incidents page.

FIG. 9 is a screen rendering on an electronic tablet of an assigned incident on the incidents page.

FIG. 10 is a screen rendering on an electronic tablet of a unit details pop-up window from an assigned incidents page.

FIG. 11 is a screen rendering on an electronic tablet of a command mode pop-up window on an assigned incidents page.

FIG. 11A is a screen rendering on an electronic tablet of a triage pop-up menu on an assigned incidents page.

FIG. 12 is a block schematic diagram of a patient care record (PCR) page on an electronic tablet.

FIG. 12A is a screen rendering on an electronic tablet of a PCR page.

FIG. 12B is a screen rendering on an electronic tablet of the page of FIG. 12 populated with patient data.

FIG. 12C is a screen rendering on an electronic tablet of the page of FIG. 12 featuring a pop-up window for entering patient identity.

FIG. 12D is a screen rendering of a chief complaint pop-up window on the PCR page.

FIG. 13 is a screen rendering on an electronic tablet of a pop-up window on the PCR page providing a graphic of a human body for entering data pertaining to a patient condition.

FIG. 14 is a screen rendering on an electronic tablet of a pop-up window accessed by a dashboard button on the PCR page showing a touch screen dial for entering a patient's pulse rate

FIG. 15 is a screen rendering on an electronic tablet of a pop-up window accessed by a dashboard button on the PCR page showing a touch screen for entry of a patient's blood pressure data.

FIG. 16 is a screen rendering on an electronic tablet of a pop-up window accessed by a dashboard button on the PCR page showing a touch screen for entry of a patient's oxygen saturation data.

FIG. 17 is a screen rendering on an electronic tablet of a pop-up window accessed by a dashboard button on the PCR page showing a touch screen for entry of a patient's EKG data.

FIG. 18 is a screen rendering on an electronic tablet of a pop-up window accessed by a dashboard button on the PCR page showing a touch screen for entry of a patient's pain data.

FIG. 19 is a screen rendering on an electronic tablet of a pop-up window on the PCR page showing treatment procedures and medication.

FIG. 20 is a screen rendering on an electronic tablet of a lower portion of the PCR page, which shows procedures, medications and transportation information.

FIG. 20A is a pop-up window, which displays run disposition information on a patient.

### DETAILED DESCRIPTION OF PREFERRED EMBODIMENT

In the following description, certain terminology is used to describe features of the invention. For example, in certain situations, the terms “component,” “unit” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic.

An example of “software” includes executable code in the form of an application, an applet, a routine or even a series of instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, etc.), a floppy diskette, an optical disk (e.g., compact disk or digital video disc “DVD”), a hard drive disk, a tape, or the like.

In a preferred embodiment, the core-layered architecture comprises a database management layer, general data collection system abstraction layer, a presentation layer, a browser, one or more system databases, and an optional interface to a computer-aided dispatch system. An embodiment with an enhanced architecture may further include interfaces/integration with one or more cell phones, fax servers, email systems, and optional third party databases, such as CAD, fleet management software, time and attendance software, incident management software and/or insurance biller software. In a preferred software implementation, software modules include an administrative dashboard, user and contact administration, a PCR data collection system including a compliance checklist function, turned in checklist function, and an electronic run form function, a search PCRs function, report administration, a notification system including an e-mail/fax PCRs function, an event notification function, and a self-monitoring and notification function, a system monitoring and notification function, a human resources (HR) function, and an online connection to provide this data via a web page.

The purpose and function of the system is to allow multiple secure users a live interactive view of the details of an emergency incident, as the events unfold.

These secure users include dispatched mobile first responder units on a 9-1-1 call, fire and EMS administration and non-dispatched mobile fire department units logged into the secure system, stationary hospital emergency rooms which may receive transported patients; and stationary billing and record keeping departments.

The entire mobile fleet will be able to view the electronic tablet display of the incident as the tablet app fields are populated. Simultaneously, all the stationary users will be able to view a Web-based interface version of the app as the incident fields are populated.

The mobile features of the system include a live interface touch screen tablet computing device presentation of the computer aided dispatch (CAD), a live map showing the hospital and unit locations with traffic alerts, personnel software showing current crews and units, patient tracking system with triage, and an electronic patient care report.

The stationary features of the system include: a live interface Website presentation with a dashboard view of all ongoing live dispatches; notification alerts of special interest, e.g., hospital closures; history of dispatched incidents; history of the care of treated patients; confidential information of treated patients; and mobile vehicle fleet status list.

All interface protocol links seamlessly through the virtual cloud. In addition to the cloud, any department in the stationary secure system may want to maintain their own servers to download and store records.

Included within the system is a separate software program. This is a unique tablet application designed to allow paramedics to complete a Patient Care Report (PCR) on a portable, low cost, lightweight, and contamination proof, touch screen G3® tablet device (for example, an iPad®). This Patient Care Report contains unique features. For instance, it: retrieves patient history records from previously transported patients; uses dropdown, one touch lists to enter patient complaints, medications, allergies, history, etc.; displays dashboard gauges, quickly and easily showing the specific and overall patient conditions, known as vitals; allows a one-touch expanded view of each vital. This expanded view duplicates the look of the medical device used to measure the vital, e.g., the B/P recording display looks exactly like a B/P cuff gauge. Readings are then entered using this one-touch gauge. As the patient's vital readings are entered, they are time-stamped and the recording medic is identified. Department-specific procedures and medications are preloaded into a dropdown list, allowing only the choices used by that department to appear. In addition, tracking of transported patients is displayed on a disposition list using dropdown fields; medical supply use automatically populates a re-order supply list; necessary signatures are entered electronically on the signature pad of the tablet; and a triage tag alert is at the top of the PCR page.

All the information recorded in this electronic PCR is seamlessly interfaced with all similar units in the system, including the ER, as the one-touch buttons are pressed. For the first time, EMS personnel will be able to take a recording device into the emergency scene, handoff the patient from the first arriving engine paramedic, to the ambulance paramedic, to the ER without re-gathering information, and the ER doctors will be able to view the PCR as it is filled in at the scene.

A system for recording medical data for a patient in an emergency first responder setting is shown. The system includes a data entry tablet having a touch sensitive screen displaying a visual user interface. The screen displays a visual representation of a plurality of patient medical conditions and parameters in one section of the screen, which are touch selected by the user. When selected each parameter causes the screen to render a gauge or dial or list representing possible patient conditions. The actual patient condition is recorded in the system by moving a pointer or slider by touch on the screen to the appropriate position whereupon the data indicated by that dial or slider position is entered and saved. A transmitter in the tablet device transmits the patient data to a remote server or cloud network. A computer terminal capable of connecting to the network accesses the data, which may appear as a webpage that can be accessed by the terminal or computer that may be, for example, located at a hospital emergency room.

The use of a touch-screen tablet computer device that renders simulations of actual dials and gauges for data entry relieves the emergency provider of the time consuming task of entering such information through an alpha numeric keypad and thus saves valuable time in an emergency setting.

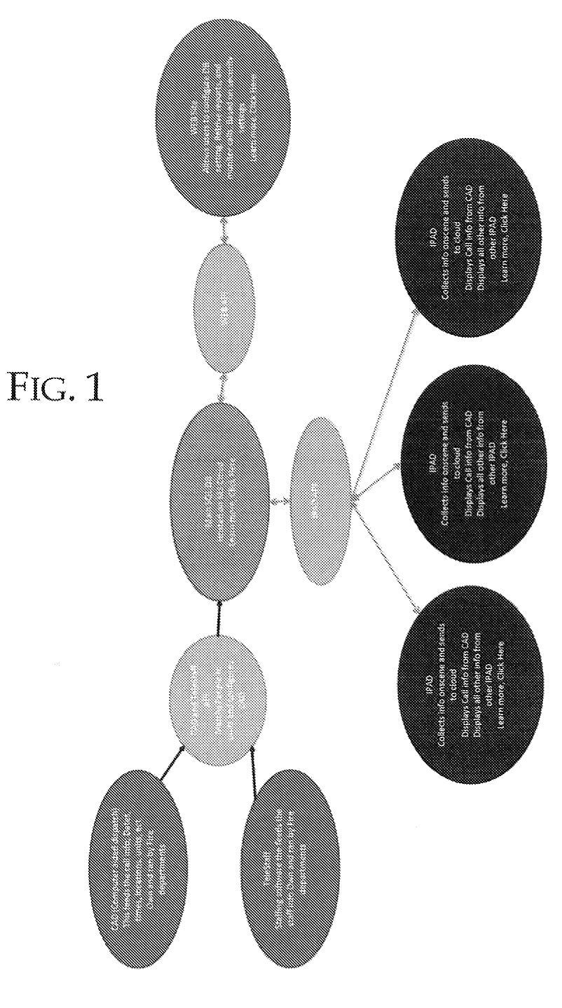

A system for managing patient care in an EMS environment is shown schematically in FIG. 1. An application for a tablet computer such as an iPad® is placed on a plurality of tablets that are carried by emergency first responders. The tablets, which may be any rugged tablet style computing device having a touch screen, communicate with a main server that may be hosted by a “cloud” service such as MS Cloud. Data are uploaded from the tablet devices to the cloud in real time and represent all data necessary to track and record the activities of emergency first responders (EMTs) and to provide hospitals and other care providers with patient data so that hospitals may be ready to receive patients upon arrival at emergency rooms. The hospitals connect to a web site hosted on the cloud in order to monitor the information uploaded by the tablet devices. Further, computer-aided dispatch software is loaded onto the cloud server, which facilitates the assignment of specific EMT units to specific locations.

The tablet devices transmit location and personnel information to the cloud and in turn, the CAD software analyses this data and assigns tasks accordingly. Team members of an EMT unit carry tablets loaded with the application described herein. On an electronic tablet, that application performs a number of functions, including communication with the cloud server to receive assignments, logging and transmission of data representing location and personnel in an EMT unit, and recording of patient data gathered at an emergency scene and transmission of that data to the cloud where it can be viewed by a hospital emergency room or other care provider on a web-connected computer or terminal.

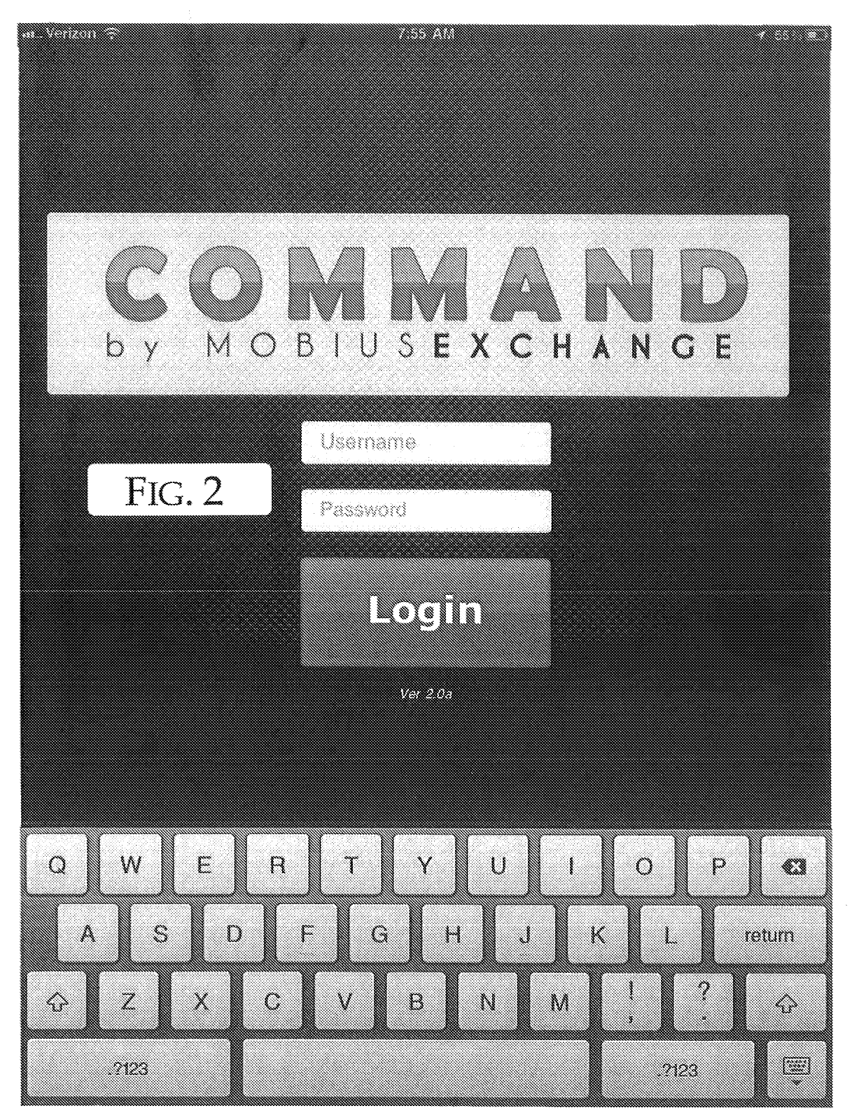

When a tablet employing the application is powered up, it displays a page shown in FIG. 2. This is a login page. As is conventional on touch-screen tablet devices such as an iPad®, a QWERTY keyboard is rendered upon a touch at a certain screen location, which provides a means of alphanumeric data entry.

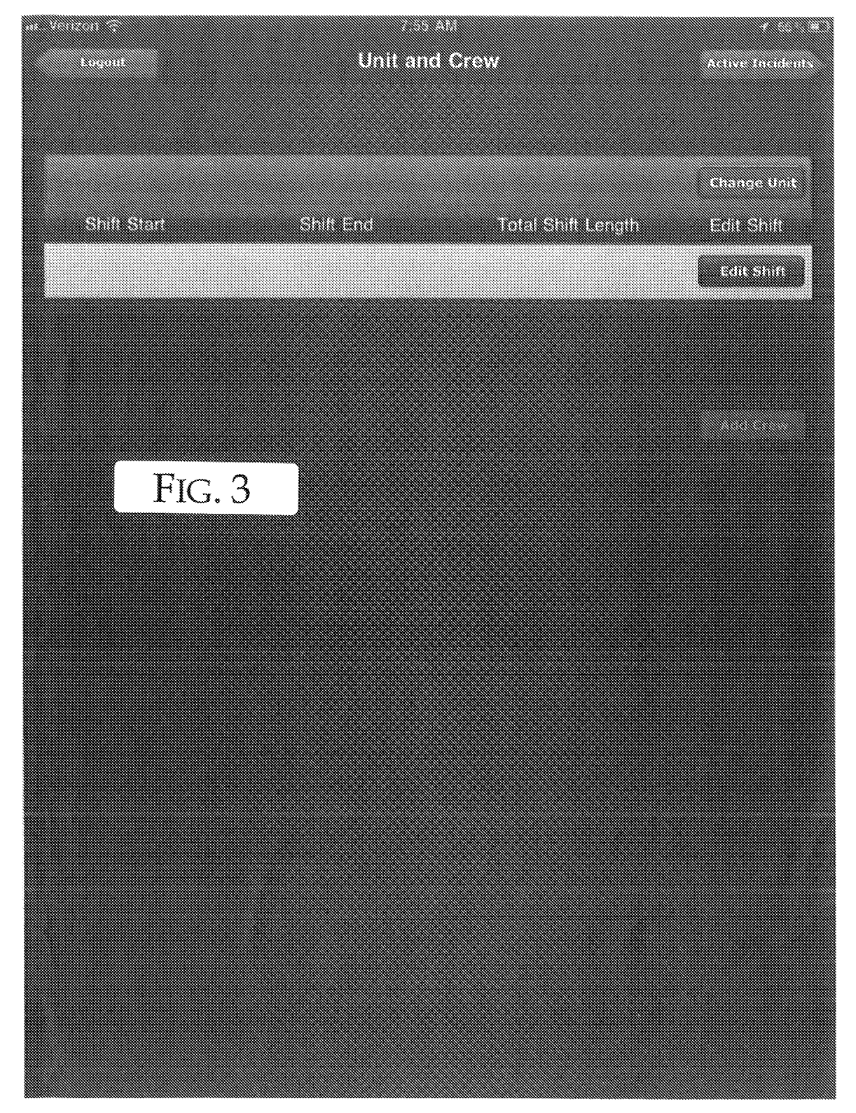

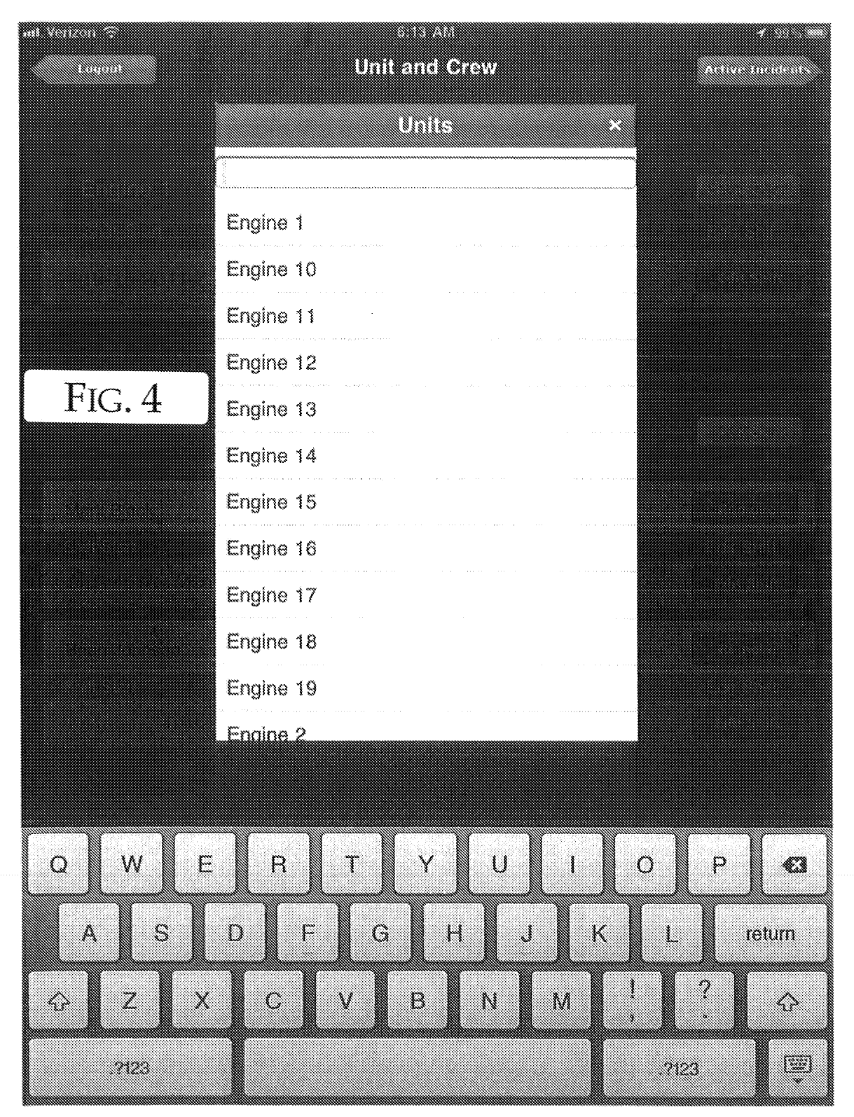

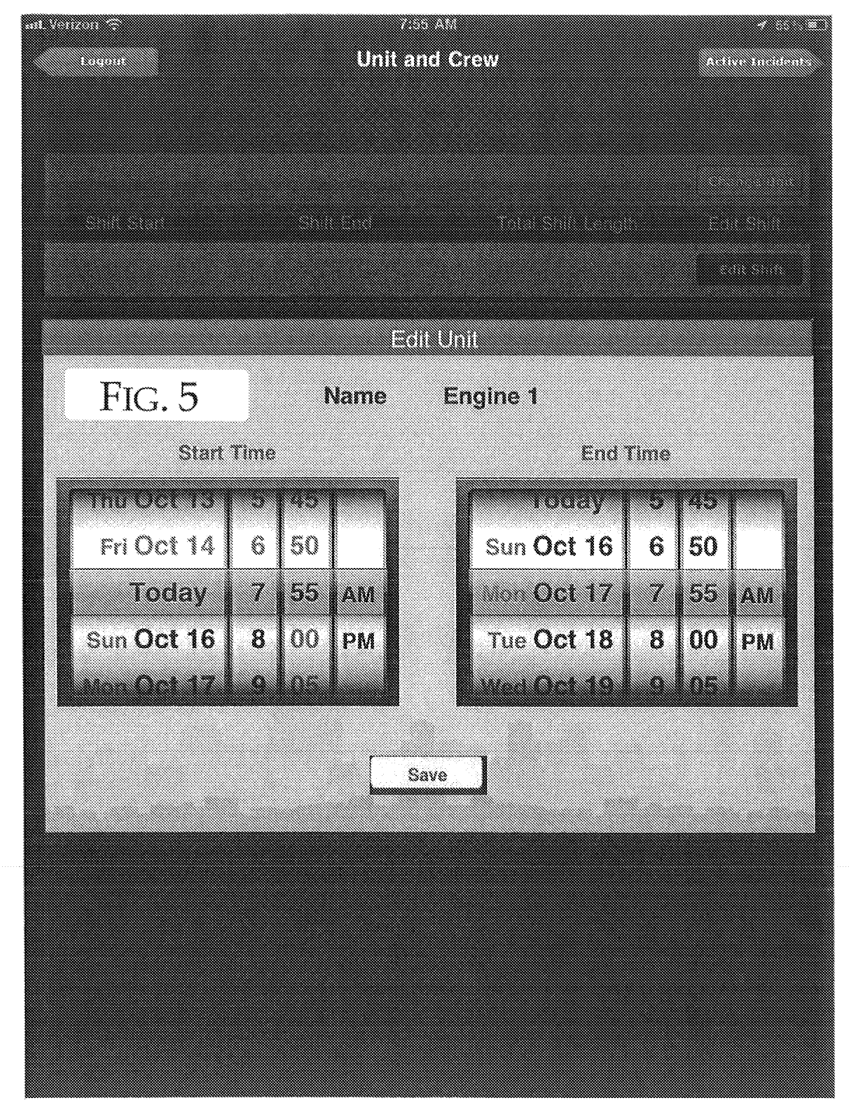

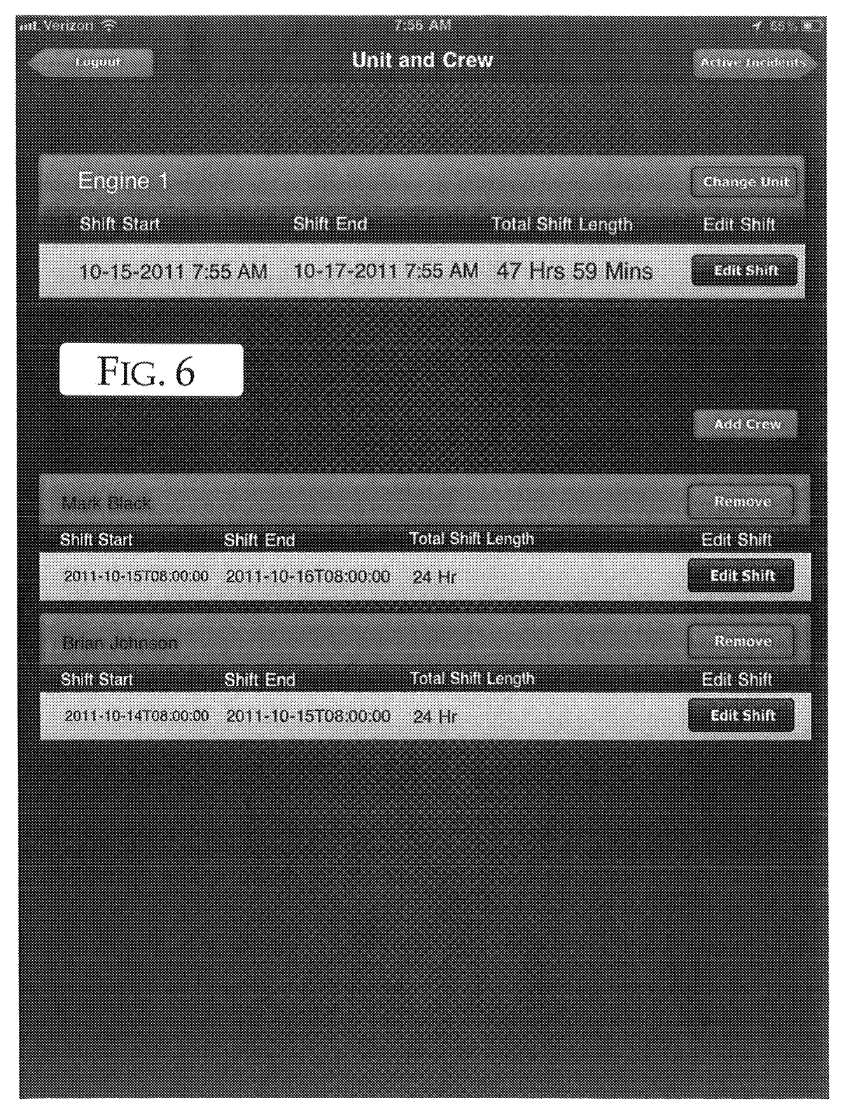

Upon login, several pages are rendered on the tablet including a unit and crew page as shown in FIG. 3. Here data pertaining to unit ID and personnel is entered, for example with the pop-up window of FIG. 4. In FIG. 5, a pop-up window displays a unit selected that may be identified along with date and time using scroll-down windows. The unit and crew page also permits identification of crewmembers and shift times as shown in FIG. 6. These pages and windows identify the particular unit, its crew and the date and time.

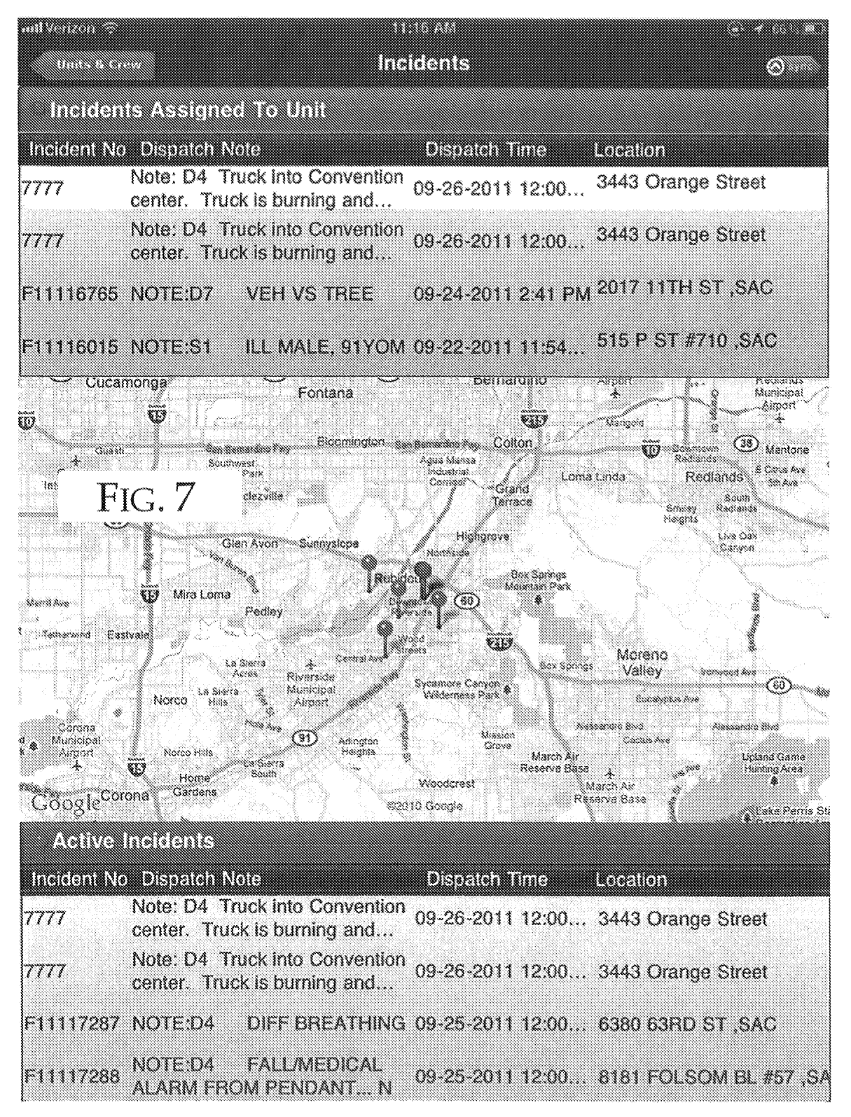

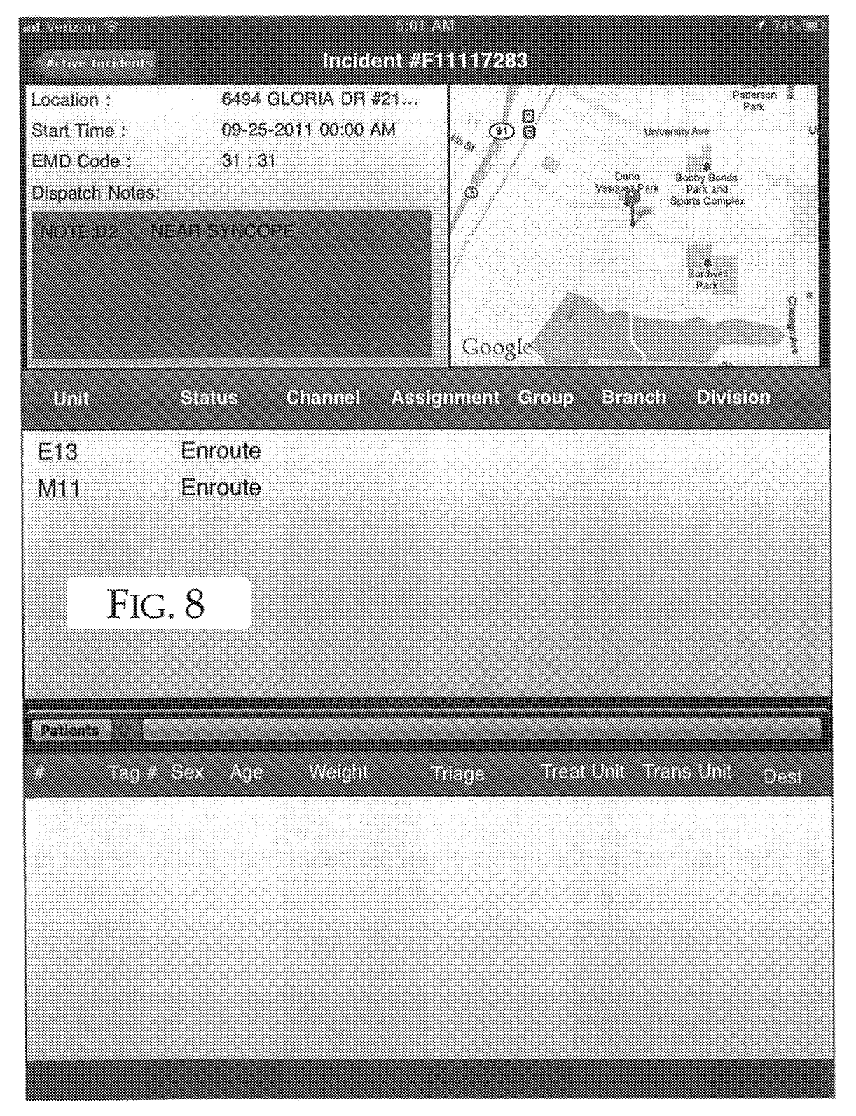

An “incidents” page is shown in FIG. 7. This data comes from the cloud server and displays the incidents assigned to a unit at the top of the page and incidents assigned to other units at the bottom of the page. It is accessed and displayed on the tablet device. In the center of the page, an Internet application like Google's Mapquest® displays the locations of the incidents in graphic form on a map. FIG. 8 displays an active incidents window and is accessed by touching the “Active Incidents” bar on the page of FIG. 7. This page displays more detail regarding the active incidents being monitored.

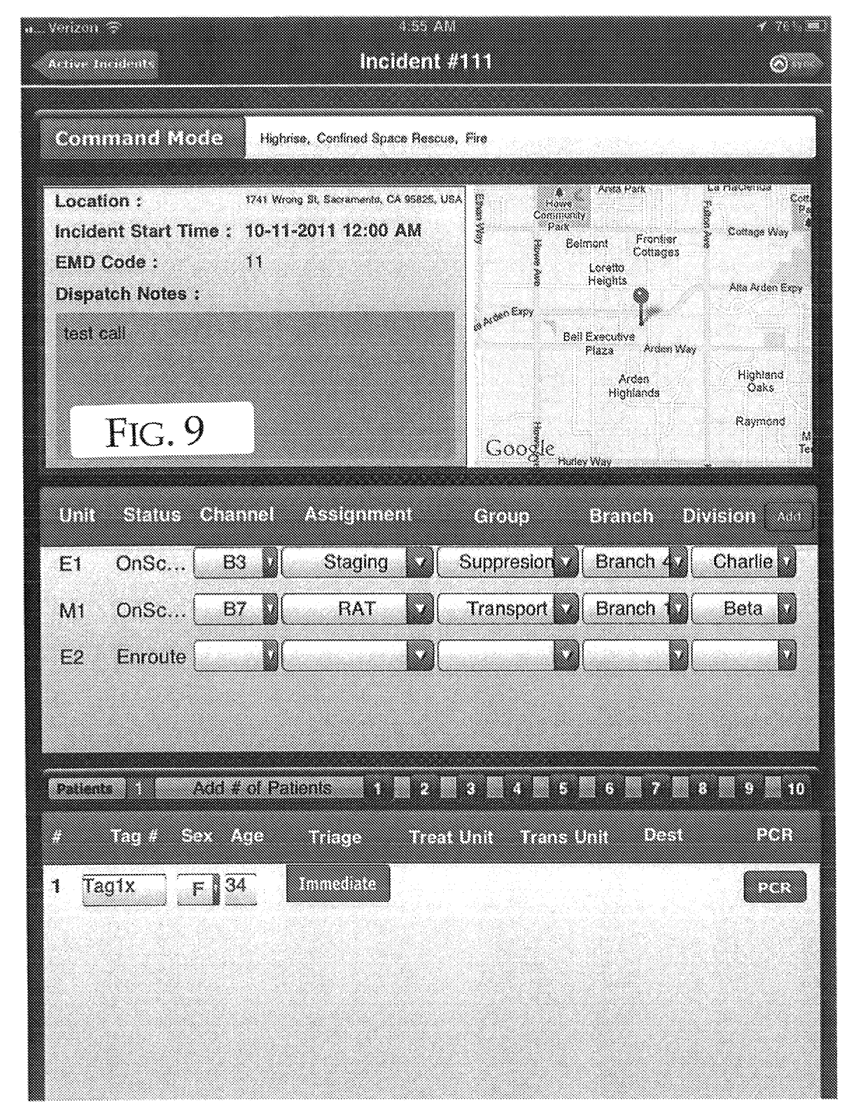

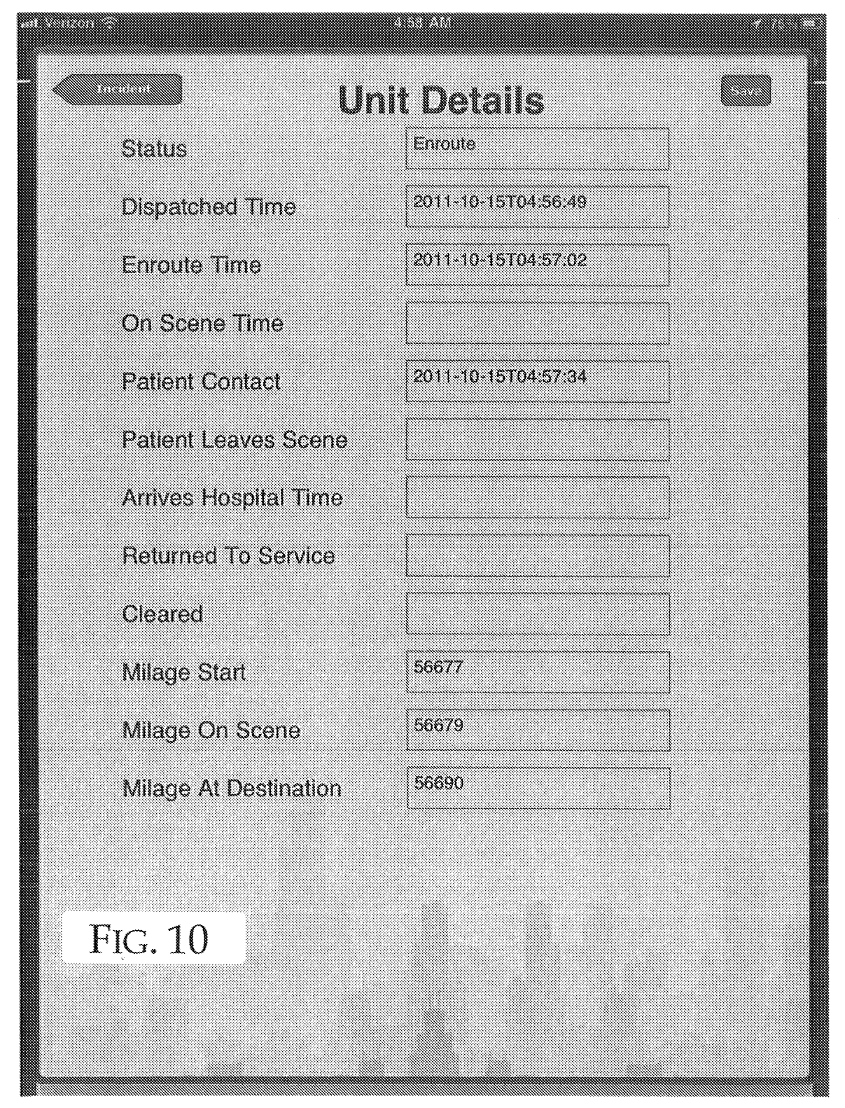

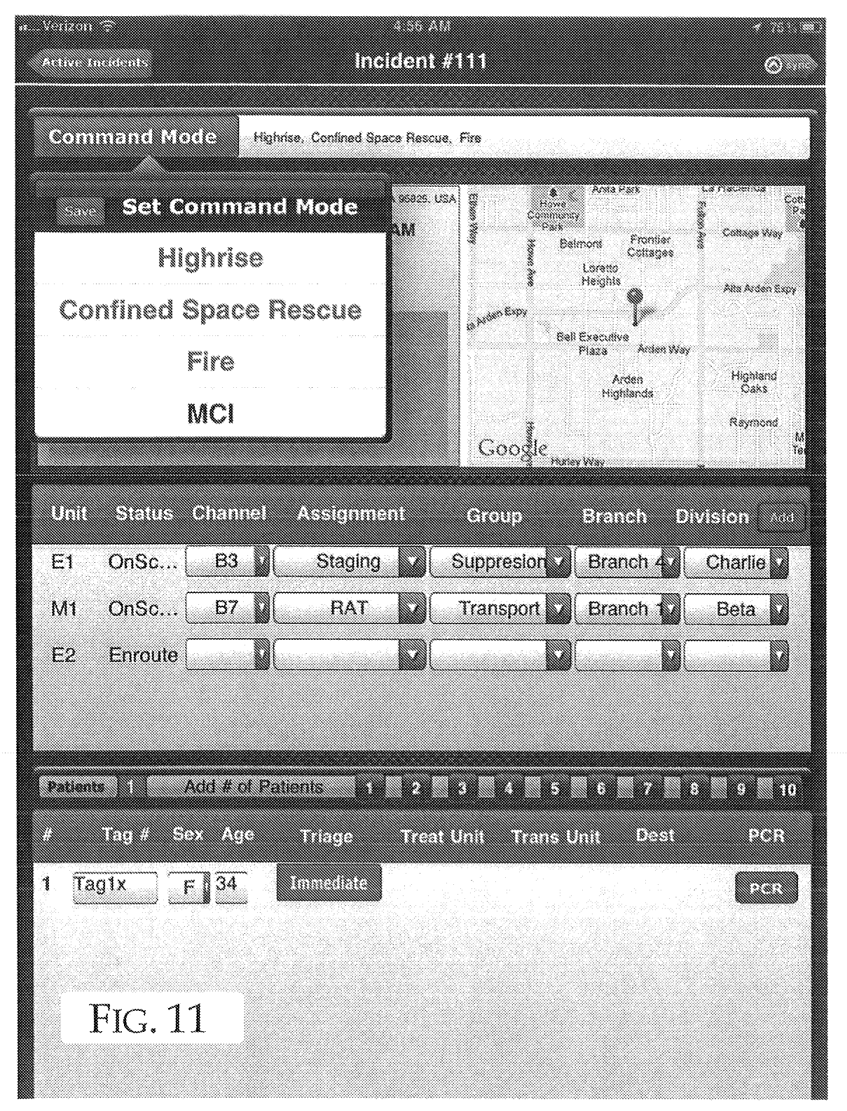

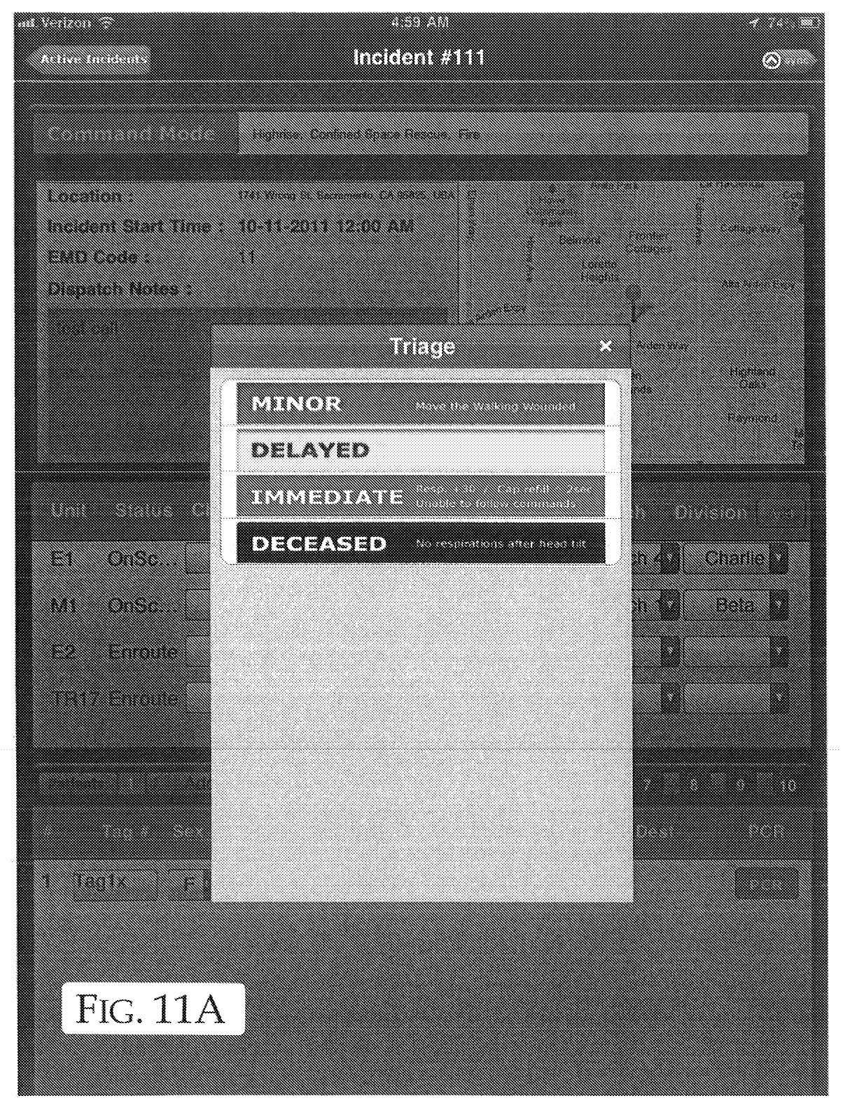

FIG. 9 is a page that displays a particular active incident. Here information as to “command mode”, such as location, time and type of incident may be recorded. The command mode is launched via the pop-up window of FIG. 11, which serves to indicate the nature of the environment of the incident. The middle of the page displays units assigned, their status, assignment, and identification. Scroll-down menus permit entry of data for each unit. Unit details, such as time and mileage, may be entered for a particular unit as shown in FIG. 10, the unit details pop-up window. The bottom of the page in FIG. 9 is a patient details recording function. Several pop-up windows permit entry of patient data from this page including triage status as shown in FIG. 11A. Touching one of the triage status bars logs that information into the system and tells the hospital the triage status of the patient at the incident site. The selection is recorded and saved by touching any of the colored tags. It may be changed later on the PCR page.

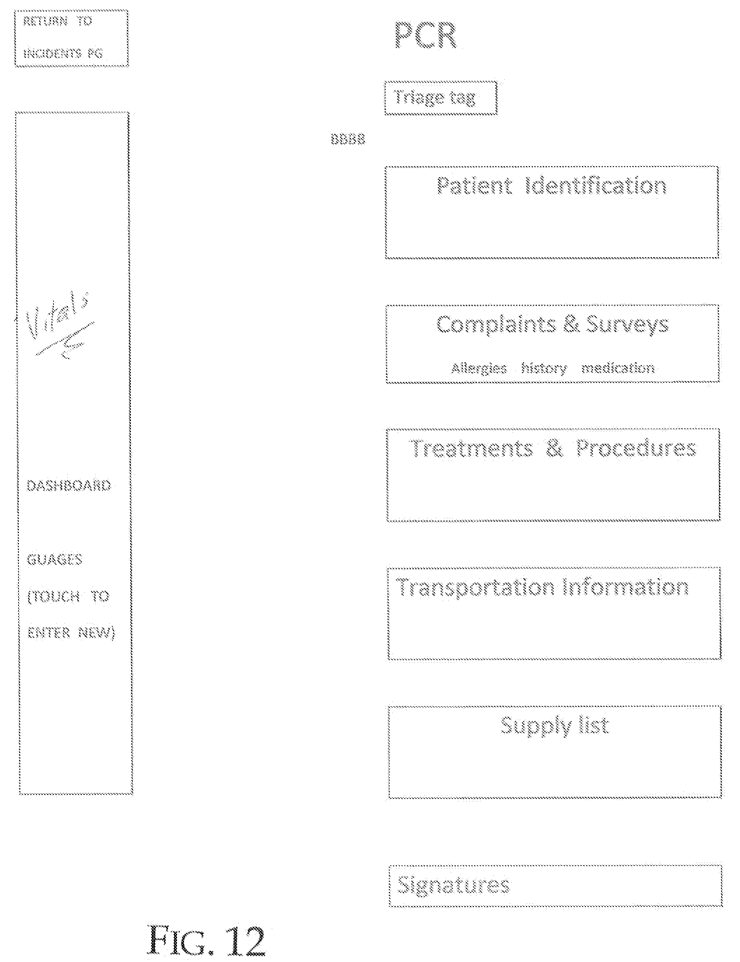

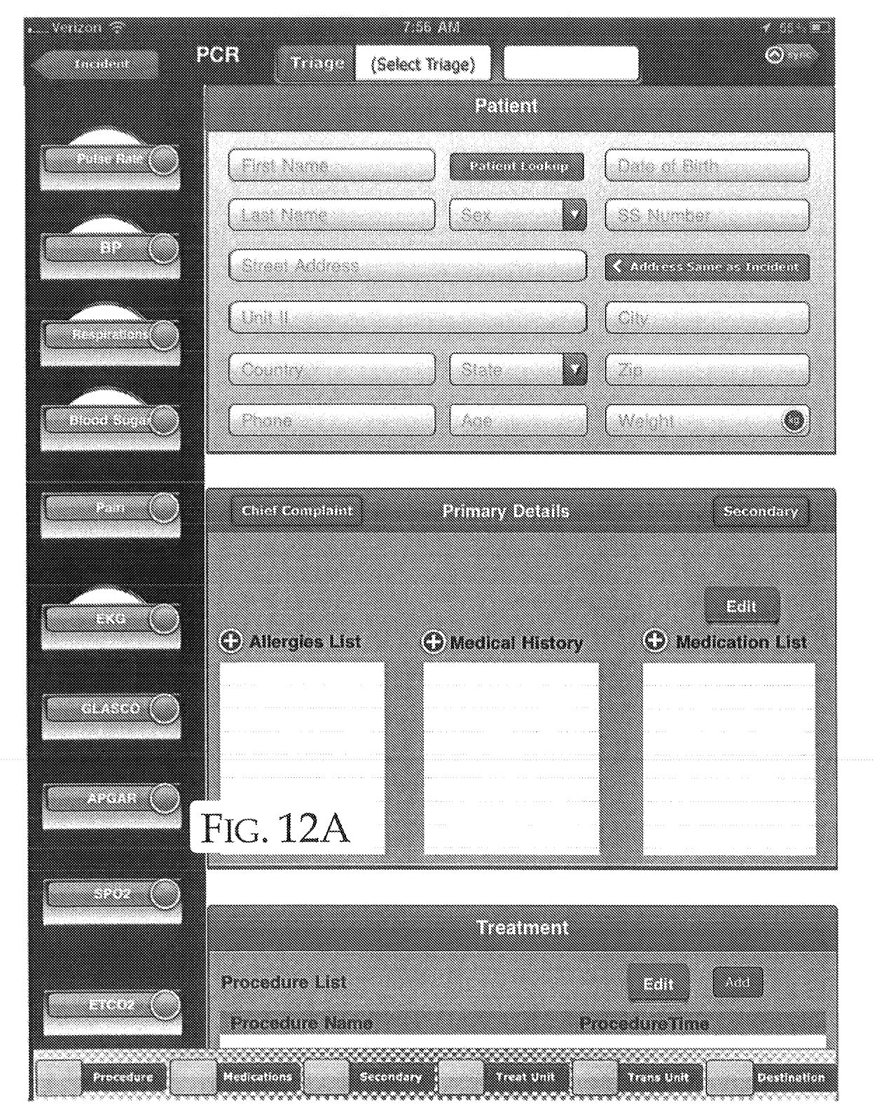

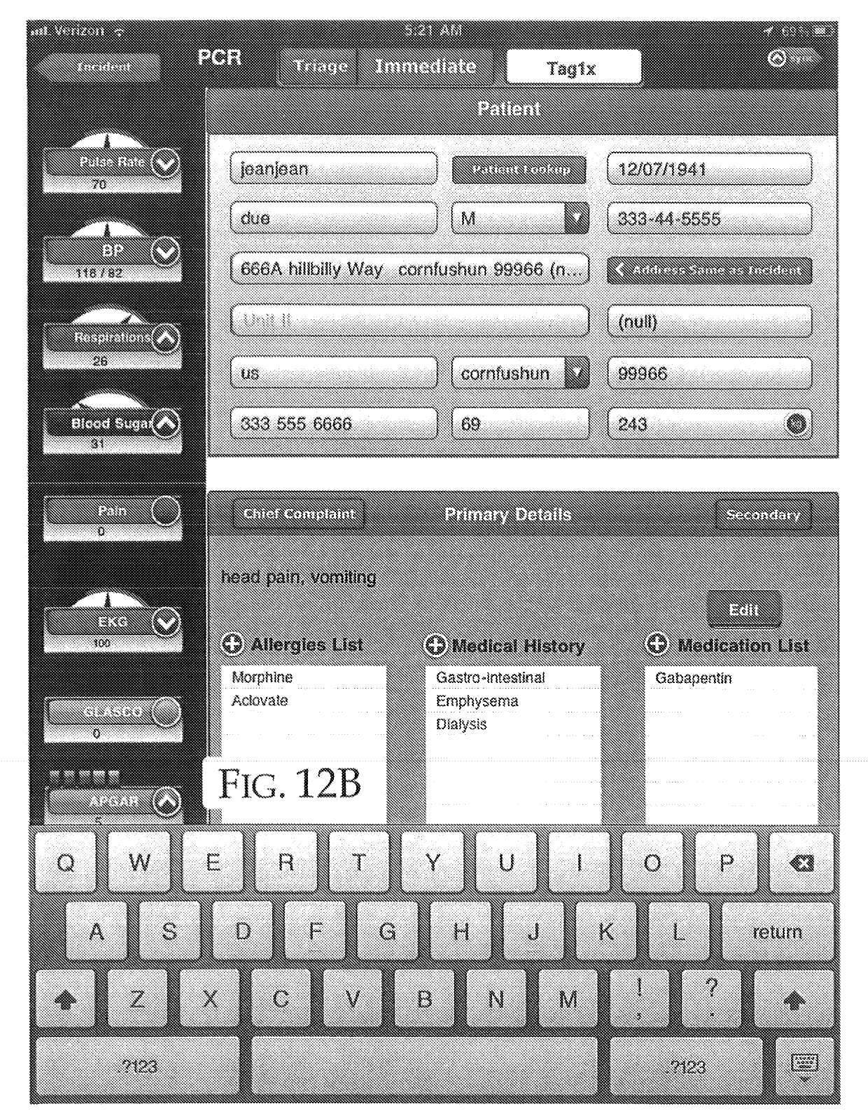

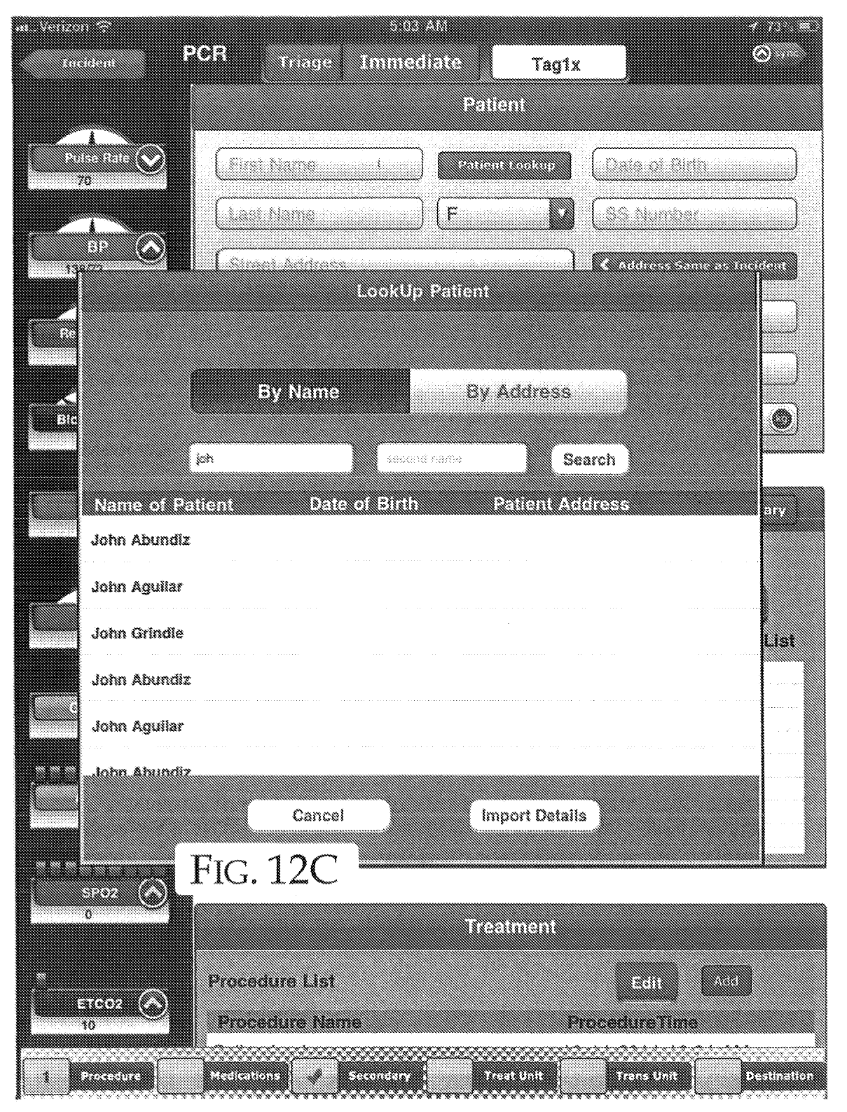

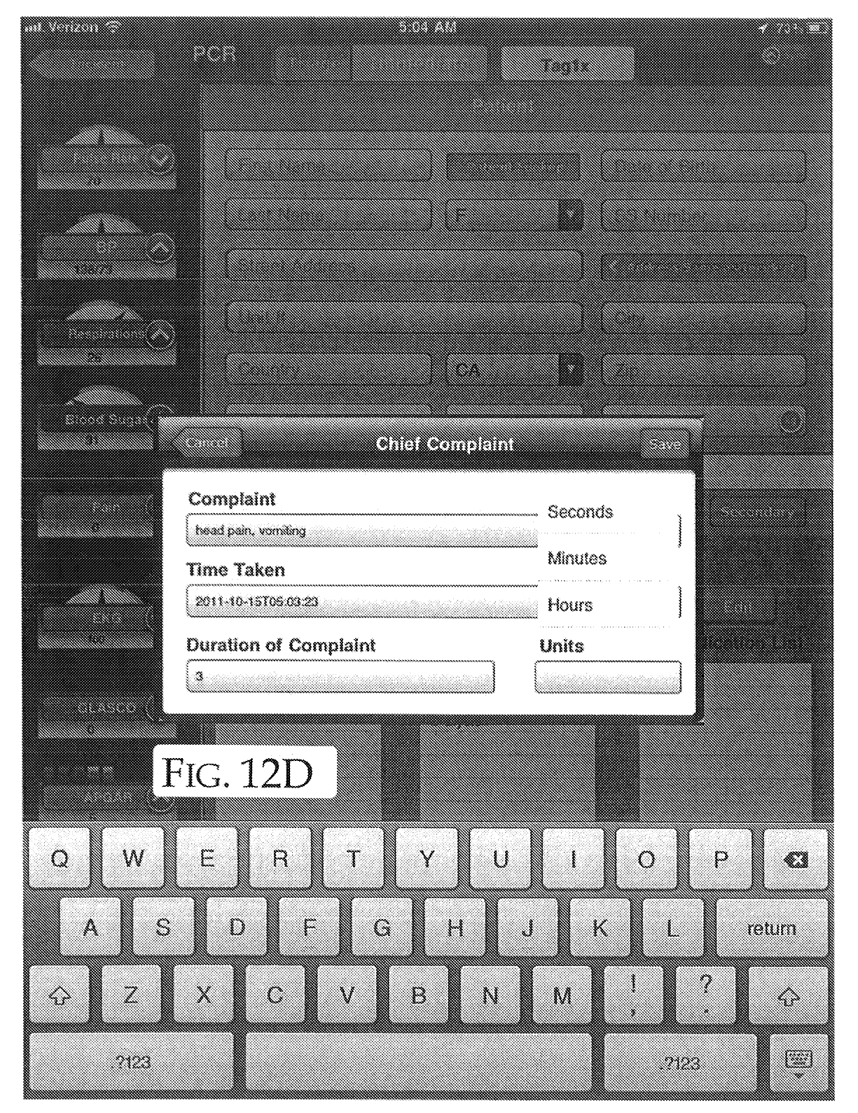

Touching the PCR button at the right of the screen launches the PCR (patient care record) page. The main PCR page is shown graphically in FIG. 12A and schematically in FIG. 12. Referring to FIGS. 12 and 12A, the PCR page has several fields for the graphic and alphanumeric entry of data on patient conditions. First, there is a triage tag, which allows entry of an immediate triage condition. Touching the triage button brings up a menu with status selections and the EMT can select the appropriate condition. Next patient ID information has a field. Under that field is a field labeled “primary details”, which provides for entry of factors such as allergies, medical history and medications in these pop-up windows. A partially filled out PCR is shown in FIG. 12B. This page can be populated with data from the cloud server if the patient has a medical history on file. Entering the patient name from the patient lookup button will do this automatically. This data may include allergies, medical history and a medication list. This can be done by using the patient lookup window in FIG. 12D and the patient may be found by either name or address.

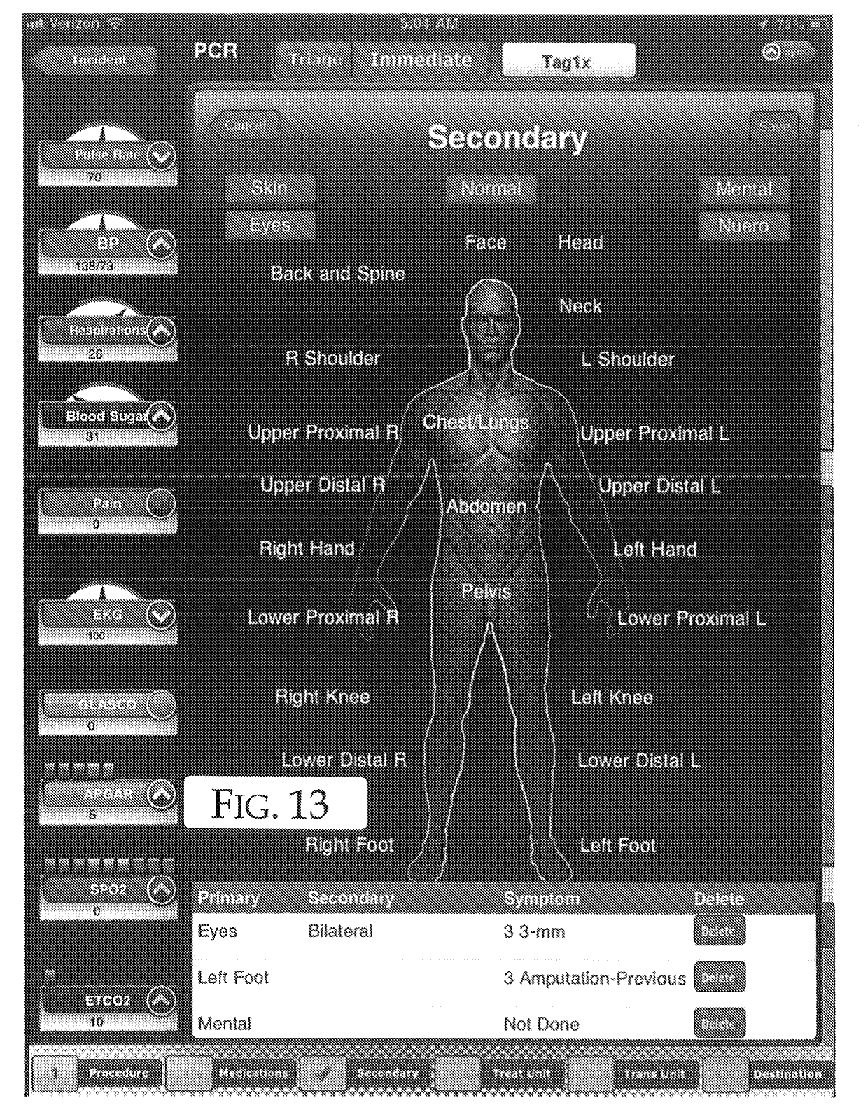

Touching the chief complaint button on the PCR page 12A brings up a pop-up window as shown in FIG. 12D and data can be entered here as to the primary patient complaint. Touching the “secondary” button brings up a graphic of the human body as shown in FIG. 13 and various symptoms and conditions may be recorded by tapping on the appropriate text opposite the body. For example, tapping “left shoulder” brings up the window in FIG. 13, and from this, a drop down menu provides choices that are entered by touching the screen. Other labeled parts of the body when touched, bring up drop down menus for conditions affecting those parts. By using a graphic of a human body and providing drop down menus, users can quickly and easily enter patient conditions that would otherwise be awkward and time consuming under emergency response conditions.

Nowhere is this feature more prominent than in the “dashboard” to the left of the PCR page. The dashboard features a list of patient parameters including pulse rate, blood pressure, respiration, blood sugar, pain index, EKG, GLASCO, APGAR, and oxygen saturation, SPO2 and ETCO2. Touching any one of the dashboard buttons causes a graphic dial or indicator containing alphanumeric values to be rendered on the screen. Patient condition data are entered by moving an index pointer to the appropriate numerical position on the dial. Thus, the operator is freed from the task of writing or typing data representing a patient's condition. Further, this data is immediately recorded and transmitted to the cloud server via wireless link, where it is available to subscribing treatment facilities such as hospital emergency rooms. Thus when the patient arrives at the emergency room, doctors on hand already have in their possession critical patient data entered on the scene by EMT personnel.

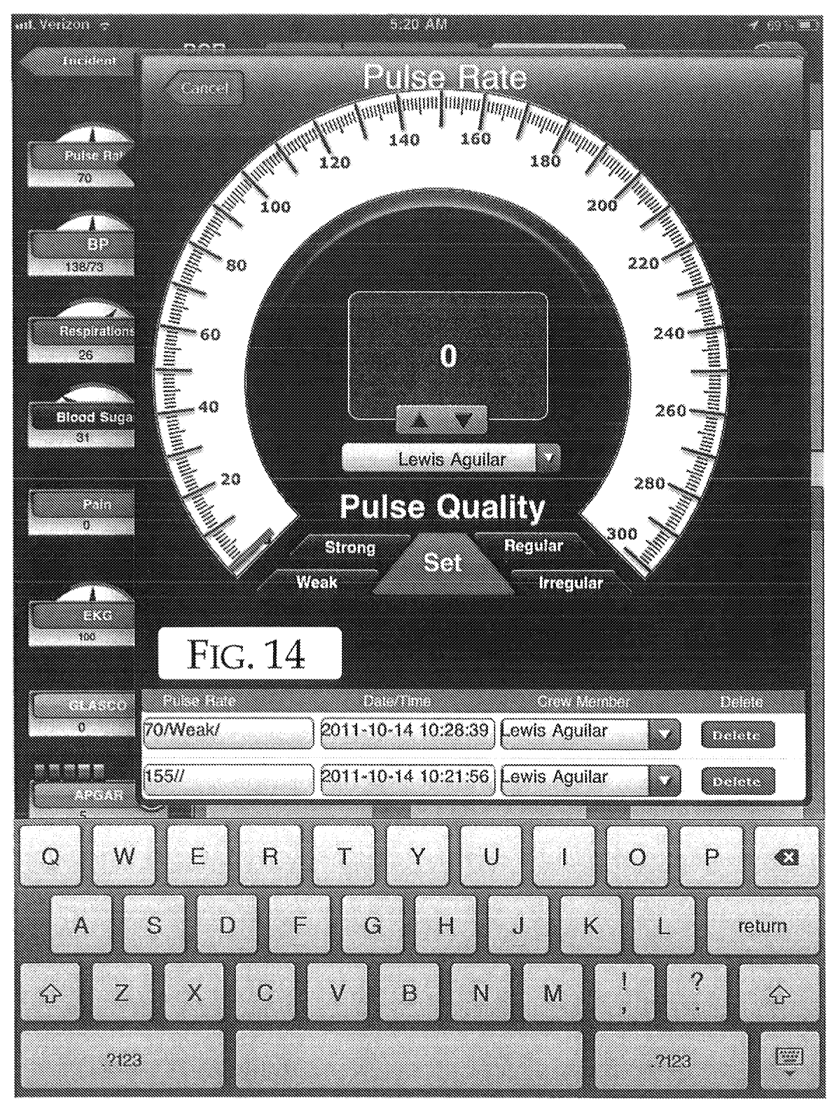

For example, FIG. 14 shows pulse rate. When the patient's pulse is taken, the EMT touches the “pulse rate” button and a dial is rendered on screen. By touching and moving the red indicator on the dial to the measured pulse rate, the pulse rate will be shown in the center box for the patient name entered. Then one of four buttons indicating the character of the pulse can be entered, i.e., “strong”, “weak”, “regular”, “irregular”. Pressing “set” saves all of this data, which has now been entered without having to tediously type it into a form.

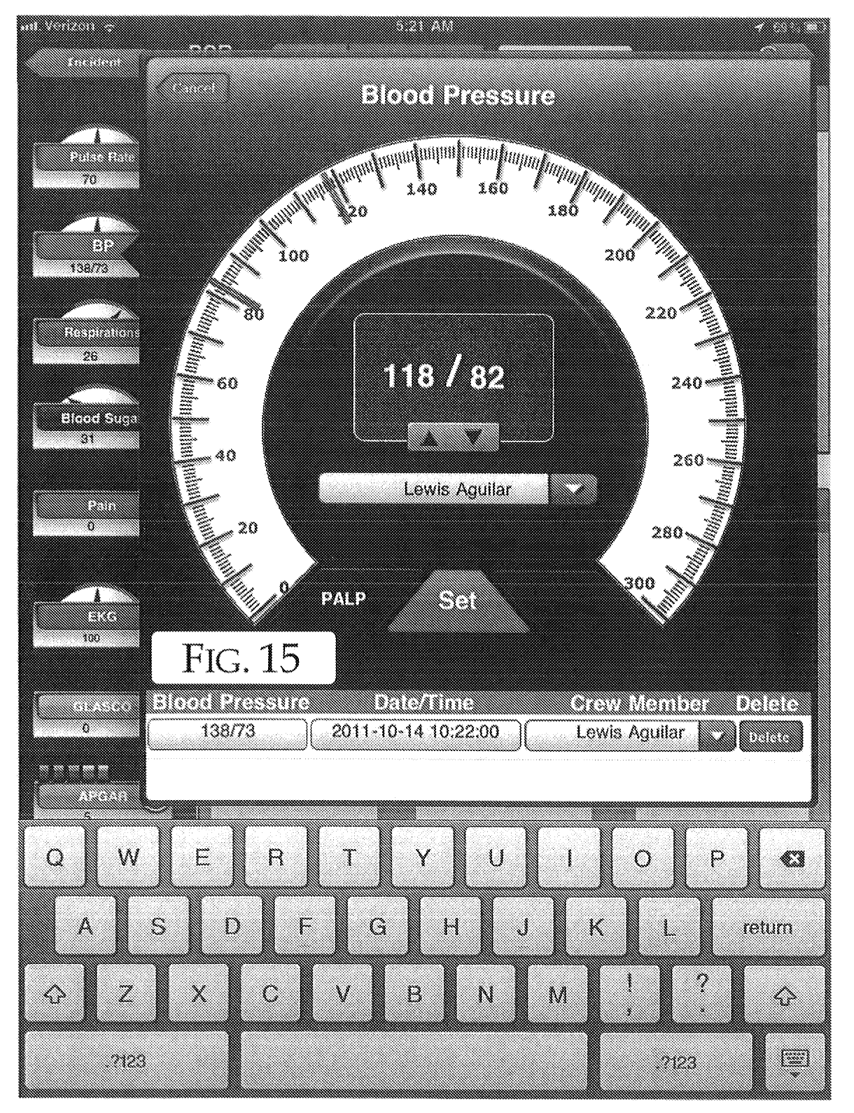

FIG. 15 shows the blood pressure gauge in which the blue pointer represents systolic pressure and the red pointer diastolic. The EMT moves the pointers by touching the screen and moving them along the dial to the measured positions. Pressing “set” logs the data into the system.

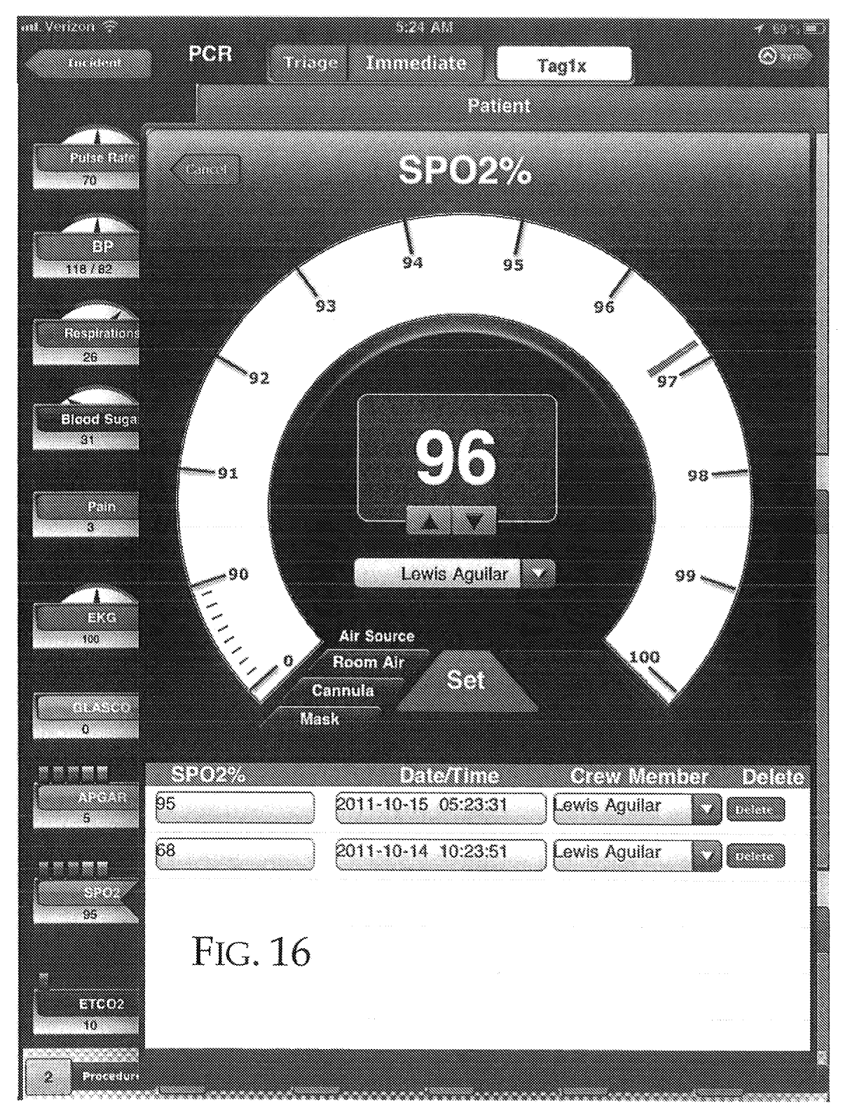

Another example of a data-input-means rendered as a dial or gauge is shown in FIG. 16, which permits the entry of blood oxygen saturation levels. A dial represents possible saturation level and touching the red pointer on the dial and moving it to the measured value causes the numbers in the center window to advance. Buttons choose the air source and the data are entered by touching “set”.

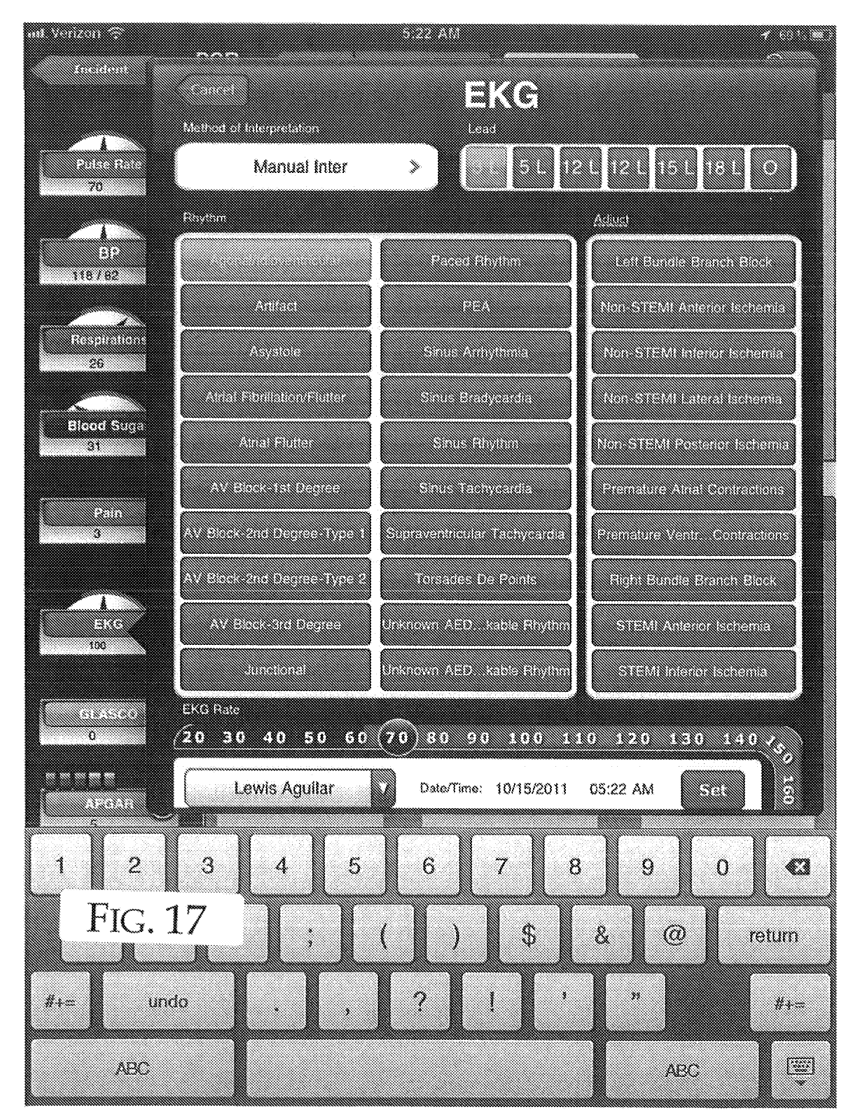

EKG data can be entered on the screen of FIG. 17. A slider that is moved by touch renders the EKG rate. Readings can be taken and the slider moved to the appropriate number after which the user presses the “set” button and the value is recorded along with the date and time.

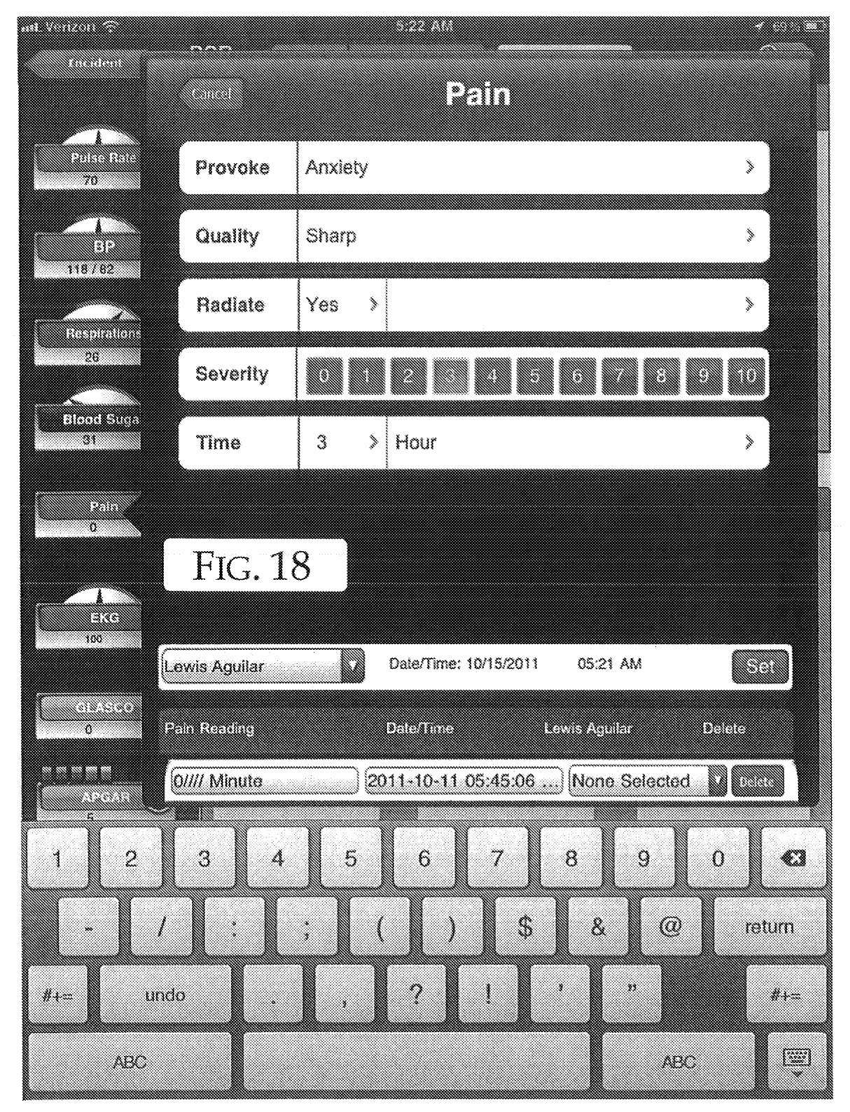

Pain data may be recorded on the screen of FIG. 18. This pop-up window provides qualitative descriptors along with a numerical severity scale. Touching each of the menu items like “provoke” and “quality” brings up a list. The appropriate description can be chosen from the list by touching it on screen. Similarly, the “severity number” can be chosen by touching it. Pressing “set” saves all the information in memory and automatically sends it to the cloud network or remote server.

A feature of the dashboard on the left side of the PCR page is that the screen icons display at a glance the parameters that have been entered so that by scanning the page EMT personnel can see a patient's overall condition. The values are displayed in blocks below a button and colors indicate the severity of the condition displayed.

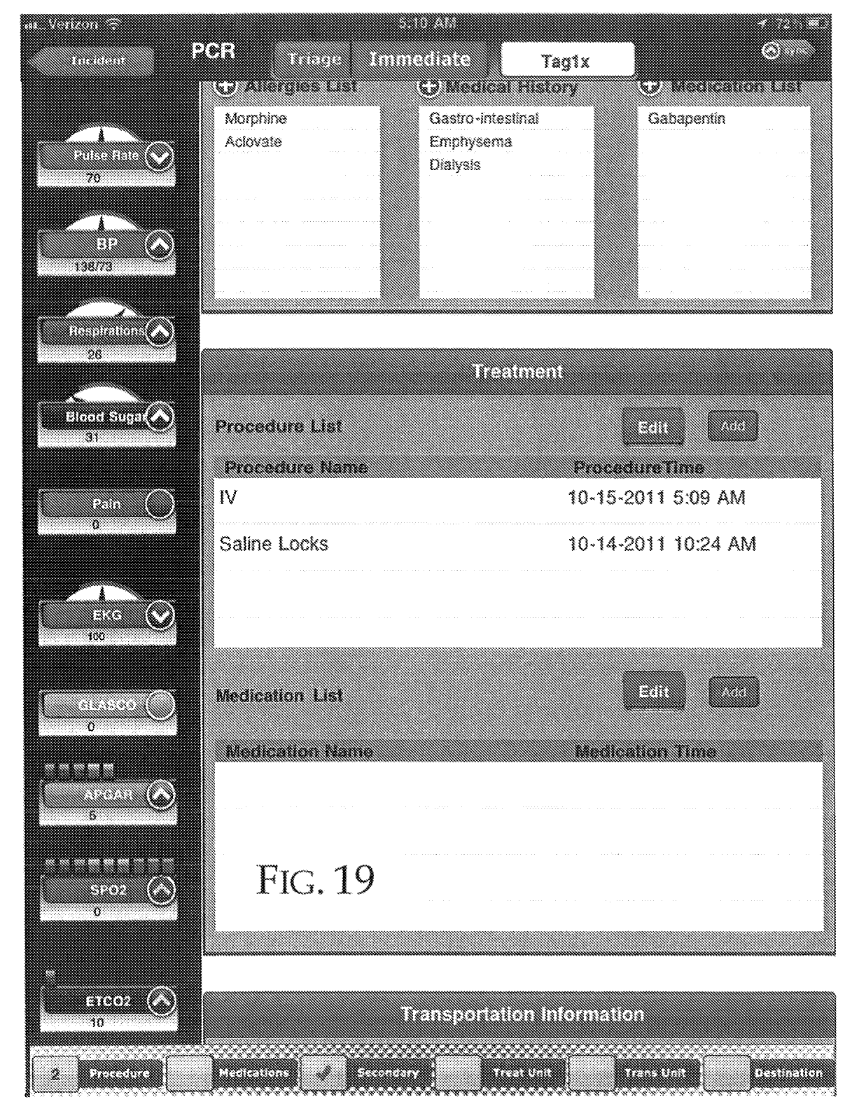

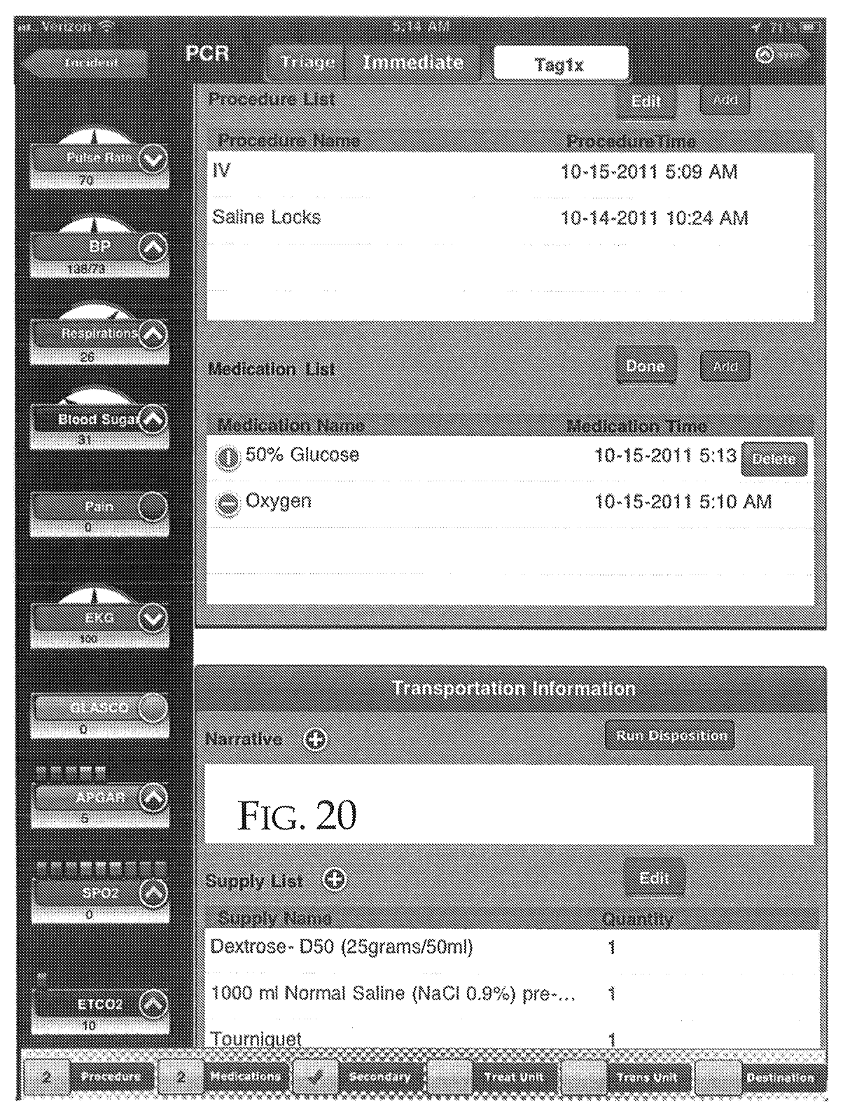

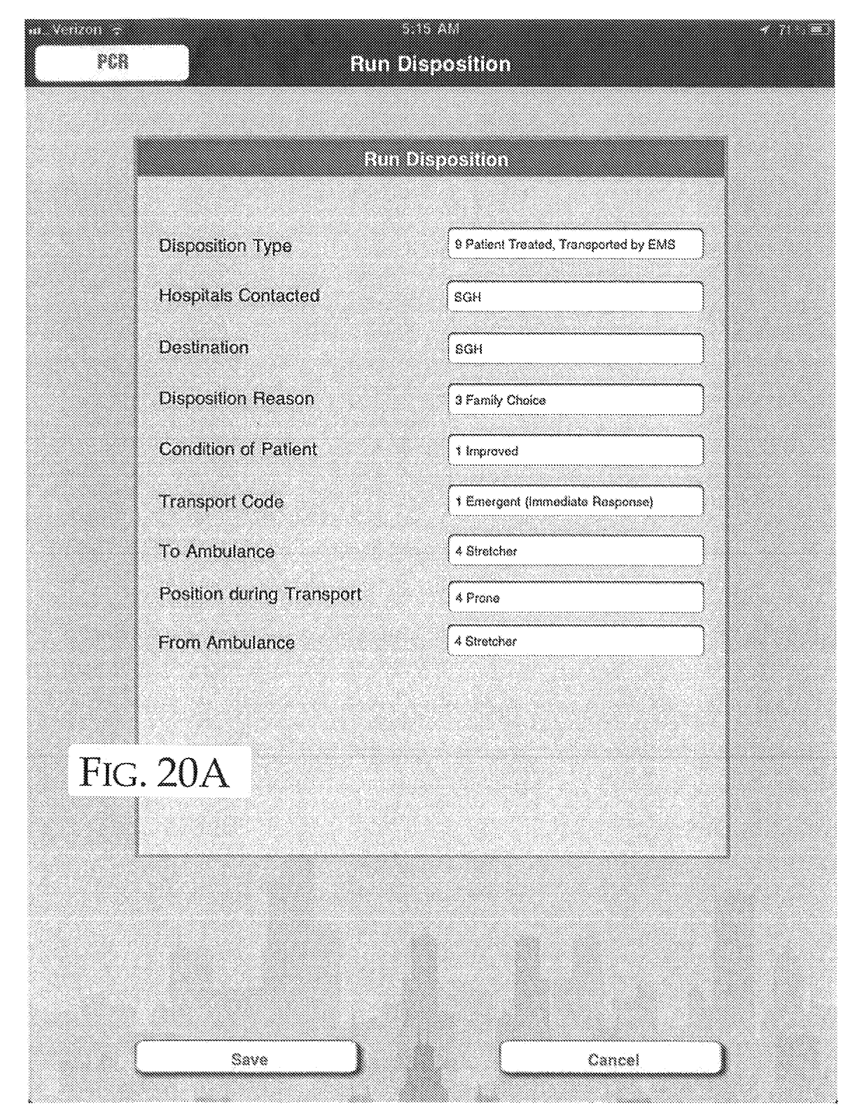

FIG. 19 shows a “treatment” window and may be used to record procedures employed and medication administered by EMT personnel. Scrolling farther down, FIG. 20 shows medication and includes a block for transportation information. A run disposition pop-up in FIG. 20A is used to log the ultimate disposition of the patient.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A system for EMS providers for collecting patient data and for communicating said data to a medical facility, comprising a portable tablet device having a touch screen, and a software program associated with said tablet device causing said tablet device to render on said touch screen selected gauges and dials simulating medical instrumentation and representing patient parameters, wherein said gauges and dials are adapted for manipulation by a user to enter patient data, a database accessible by said medical facility, said portable tablet device being in communication with said database whereby said patient data is transmitted to said medical facility.

2. The system of claim 1 wherein said database is a cloud database linked to the Internet.

3. The system of claim 1 wherein said tablet device is programmed to render a representation of a human body and selected points on said representation of said human body provide drop-down menus listing possible trauma when touched by a user, whereby said trauma may be selected and included as part of said patient data.
